(19) United States
(12) Patent Application Publication
(10) Pub. No.: US 2015/0074647 A1
(43) Pub. Date: Mar. 12, 2015

(54) TESTING SYSTEM FOR AN INTEGRATED SOFTWARE SYSTEM

(71) Applicant: Doron Levi, Modiin (IL)

(72) Inventor: Doron Levi, Modiin (IL)

(21) Appl. No.: 14/391,686

(22) PCT Filed: Apr. 20, 2012
(86) PCT No.: PCT/US12/34395

§ 371 Date: Oct. 9, 2014

(51) Int. Cl. G06F 11/36

(52) U.S. Cl. CPC G06F 11/3672
USPC 717/124

(57) ABSTRACT

Systems and methods for testing an integrated software system. A mock object (18) includes an aspect joined to a corresponding object (16) within the integrated software system. The mock object (18) intercepts a method call associated with the corresponding object (16) and routes the method call to one of the corresponding object and programmed behavior associated with the mock object. A testing agent (20) instructs the aspect to route the method call to the one of the method associated with corresponding object (16) and the programmed behavior associated with the mock object (18).

### TECHNICAL FIELD

This invention relates to software testing, and more particularly, to a testing system for integration testing.

### BACKGROUND

Software testing plays a role in the development of computer software and is used to confirm whether or not the quality or performance of a software program conforms to some requirements raised before the development of the software. Software testing is an inspection of software requirement analysis, design specification description and coding before software is put into practice and is a key step for guaranteeing software quality. Software testing is a process of executing a program in order to find errors. Software testing may be divided into unit testing and integration testing, wherein unit testing is a testing of the minimum unit of software design, while integration testing is a testing of the whole software system. After respective modules having passed unit testing are assembled together according to design requirements, integration testing is performed so as to find various interface-related errors.

### BRIEF DESCRIPTION OF THE DRAWINGS

FIG. 1 illustrates a testing system for an integrated software system;

FIG. 2 illustrates one example of a composite applications testing system in an integrated software system;

FIG. 3 illustrates a recorder system for capturing desired behaviors for mock objects to generate testing scenarios;

FIG. 4 illustrates one method for testing an integrated software system;

FIG. 5 illustrates one example of a method for invoking a composite object; and

FIG. 6 is a schematic block diagram illustrating an exemplary system of hardware components.

### DETAILED DESCRIPTION

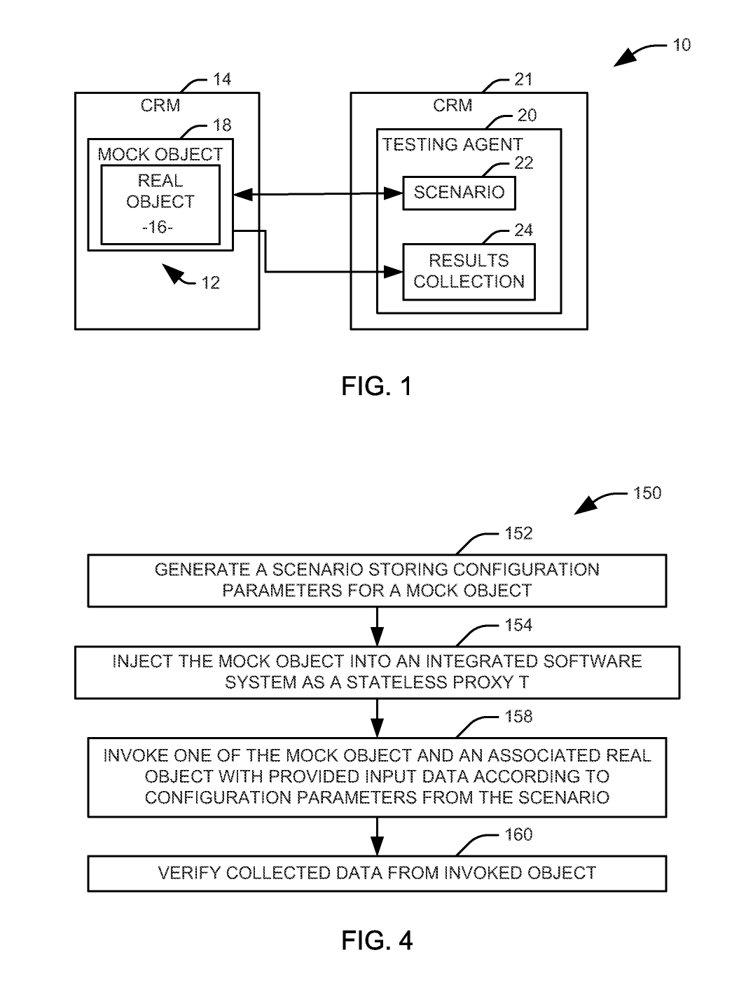

FIG. 1 illustrates a testing system 10 for an integrated software system. The system includes a composite object 12 implemented as machine executable instructions on a first non-transitory computer readable medium (CRM) 14. The composite object 12 includes an implemented object 16 within the integrated software system, referred to herein as a “real object,” and a mock object 18 implemented as an aspect wrapped around the real object 16. Specifically, the mock object 18 is a dynamic proxy that intercepts all method calls and can route them to real implementation of the method or a mocked implementation, implemented as programmed behavior based on a current configuration. The mock object 18 can be injected into the integrated software system, for example, using aspect oriented programming (AOP) frameworks, intermediate language or byte code weaving, or code instrumentation.

A testing agent 20 manages a context of the composite object 12, wherein the context includes a virtual state of the mock object 18, an instruction to use either the mock implementation or the real implementation for a given method, and collected input and output data for the composite object. In the illustrated implementation, the testing agent 20 is implemented as machine executable instructions on a second non-transitory computer readable medium 21, although it will be appreciated that the testing agent could also be implemented on the first non-transitory computer readable medium 14. The testing agent 20 includes configuration data to instruct the mock object 18 to route incoming method calls to respective real implementations or mocked implementations. A given mock object 18 can be instructed to always use programmed behavior, always invoke the real object 16, or invoke the programmed behavior only for specific methods associated with the object. Any process can be configured to contain a testing agent 20 for remote control.

The testing agent 20 includes a scenario 22 to store configuration data for the mock object 18 representing methods associated with the real object 16. For example, the scenario 22 can include a programmed collection of steps for each unique method signature associated with the mocked real object to model its behavior in response to invocation of the mock object. The programmed behaviors can include return values, output and reference parameter values, exception throwing, event raising, callback execution, and similar behaviors. During execution, the mock object 16 refers to the scenario 22 to determine how it should proceed when an associated method is invoked. If the real object is determined to be appropriate for a given method, it is executed in the normal fashion to produce an output. If a mocked implementation is desirable, programmed behavior from the scenario 22 is executed to provide an output for the method. In one implementation, the mock object 12 is one of a plurality of mock objects, and the scenario 22 comprises a hierarchical data structure storing configuration data for each of the plurality of mock objects.

The testing agent can further include a results collection component 24 to collect input data provided to the composite object 16 and outputs generated by the mock object 16 or the real object 18. At predetermined intervals, the collected values are transmitted to a central testing service (not shown) where they can be verified against expected values. In one implementation, the results collection component 24 selectively collects the input data and outputs such that less than all of the input data and outputs are collected. By selectively collecting input and output data, an efficiency of the testing system 10 can be enhanced.

The illustrated system provides a number of advantages. For example, developers are able to test against regular interfaces using the tests authoring and execution frameworks of their choice. Any interface can be completely virtualized if it is not yet implemented. The programmed behaviors can be made completely consistent. The testing configuration can be done against the interface locally while during execution, the mock objects will be created remotely. Also, it is possible to switch the configuration of remote objects on the fly, including a switch from mocked to real implementation, without restarting the system. Data gathered automatically from remote mocked and real implementation execution can be fine-tuned to collect only desired and transferable information. Finally, the system is well suited for handling negative scenarios, such as bypassing mechanisms, simulating resources outages, timeouts, and unexpected exception throwing.

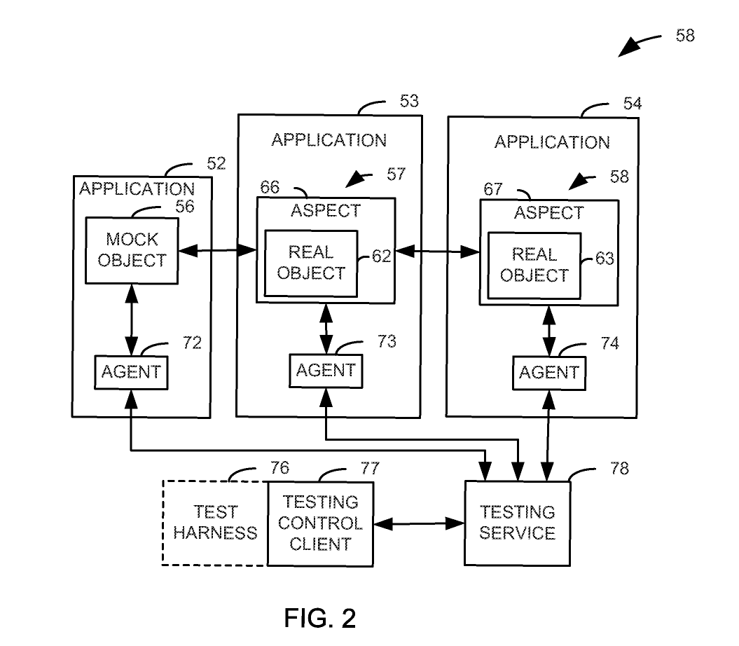

FIG. 2 illustrates one example of a composite applications testing system in an integrated software system 50. The system includes a plurality of applications 52-54 each containing an object 56-58. It will be appreciated that a given application 52-54 can include multiple objects, but each application 52-54 is illustrated here with a single object for simplicity of explanation. The objects 56-58 can include mock objects 56 and composite objects 57 and 58. Mock objects 56 are stateless proxies that can be injected into the system or created at a time of execution. Mock objects 56 represent system components that are either not completed or undesirable to include when performing integration testing. Composite objects 57 and 58 include implemented application components 62 and 63 wrapped in respective mock object aspects 66 and 67.

A given mock or composite object can include an input data collector for receiving and recording input data provided to the mock object from other system components as well as an output data collector for recording output data provided in response to received input. In one implementation, each mock object 56, 66, and 67 can include a number of preexecution and postexecution triggers to provide custom behaviors for the mock object that can be executed in response to an event. For example, the trigger can be executed in response to input data provided to the mock object, outputs generated by the mock object, or invocation of a method associated with the mock object.

A given application 52-54 can further include a testing agent 72-74 to allow for remote control and monitoring of the processes associated with the application. For example, each testing agent 72-74 can include configuration data for the behaviors of a mock object stored in a portable data model referred to as a scenario. Each scenario is implemented as a hierarchical data structure storing configuration data representing the behaviors of the mock object or mock objects that it represents. For example, for each mock object, an associated plurality of methods can be represented as a collection of method steps, with associated configuration data. Each collection of method steps can be associated with the mock type and a unique method signature.

The scenario also contains configuration data for each composite object (e.g., 57) in its associated application (e.g., 52) to instruct the composite object to either execute the behavior associated with its real object, the method steps stored at the scenario, or to select between the two based on the specific method invoked. For example, a given composite object can have some, but not all, of its associated methods represented in the scenario, and the programmed behavior at the scenario can be used for those methods for which it has been defined. Data collection rules specific to each method that govern the specific input and output data collected when each method is invoked can also be stored at the scenario. Each testing agent 72-74 further includes a results collection component to collect input data and outputs from the mock object or the real object in accordance with the data collection rules stored at the scenario. In one implementation, the results collection system is implemented as a data binding model in which each of the plurality of objects 56-58 are linked to a property bag that stores data from the mock object. Accordingly, data from each instance of the mock object is provided to a corresponding instance of the associated property bag.

The use of the data binding model allows for virtualization of the data access layer when it is desirable to created a large amount of objects of the same type that still have some variation in the data they contain. Instead of configuring a large number of mock objects, the data binding model links mock objects to property bags that contain the data. Specifically, the unique mock object instance id of each mock object instance is linked with the property bag id. From the property bag id, it is possible to link the property bag in the data source and take all the mock object fields data from the property bag, using some naming convention between the field names in the object and the property names in the property bag. It will be noted that a few mock object instances may point to the same property bag.

The system 50 interacts with a test harness 76 that provides an interface for an associated user and generally manages a context of the testing environment. The test harness 76 can include any testing framework selected by a user for performing the integration testing. In the illustrated system, the test harness 76 can remotely control interfaces programmed locally and then assert on data gathered remotely. The test harness 76 can be operatively connected to a testing services client 77 associated with the system 50 to allow communication with a testing service 78. For example, the testing services client 77 can provide an application program interface to accommodate a selected test harness. A user can provide a generated scenario to the testing service 78 through the test harness 76 to provide a behavior configuration for the mock and composite objects 56-58. In the illustrated system, the testing service 78 maintains a list of the agents 72-74, and after all agents confirm they switched to the new scenario, the control is returned to the test harness 76 for the test execution. Since the various mock objects 56, 66, and 67 are stateless proxies, a new scenario can be provided at any time to completely alter the behavior of the mock objects or dynamically switch between a real implementation and a mock implementation, even when the testing environment is live. Each testing agent periodically and asynchronically updates the testing service 77 with collected data. In one implementation, the agents can send data via hypertext transfer protocol (HTTP) to a central testing service. For example, after a predefined period the agent sends execution collected data and asks the service if there are any new commands to execute (e.g., if there is a new scenario to apply). The testing service 77 can include a data inspection component (not shown) to verify that the collected input and output data follows rules specified in the scenario. For example, the rules can include expected input parameter values, expected output parameter values, expected return values, expected numbers of calls, expected failures for various exceptions, and a check for successful termination of the method.

During execution, when an object 56-58 is invoked, it can either execute the real behavior for the object or request instructions from the active scenario on how to proceed based on the parameters stored at the scenario and act accordingly, depending on whether the object is configured to provide real, mocked, or dynamic behavior. Input data and outputs from the object, including output parameters, returned values, and raised exceptions, can be collected at the agents 72-74, with the results provided to the testing service 77 for validation. It will be appreciated that the data can be collected selectively, with only data relevant to a given test collected. The objects can also support preexecution and postexecution triggers, which are custom behaviors that can be programmed into the mock object 56, 66, and 67. These triggers can be conditioned on a particular event associated with the input or output data or simply configured to execute every time the object is invoked. For example, an object 56-58 may be instructed to sleep for a given number of milliseconds after it is invoked.

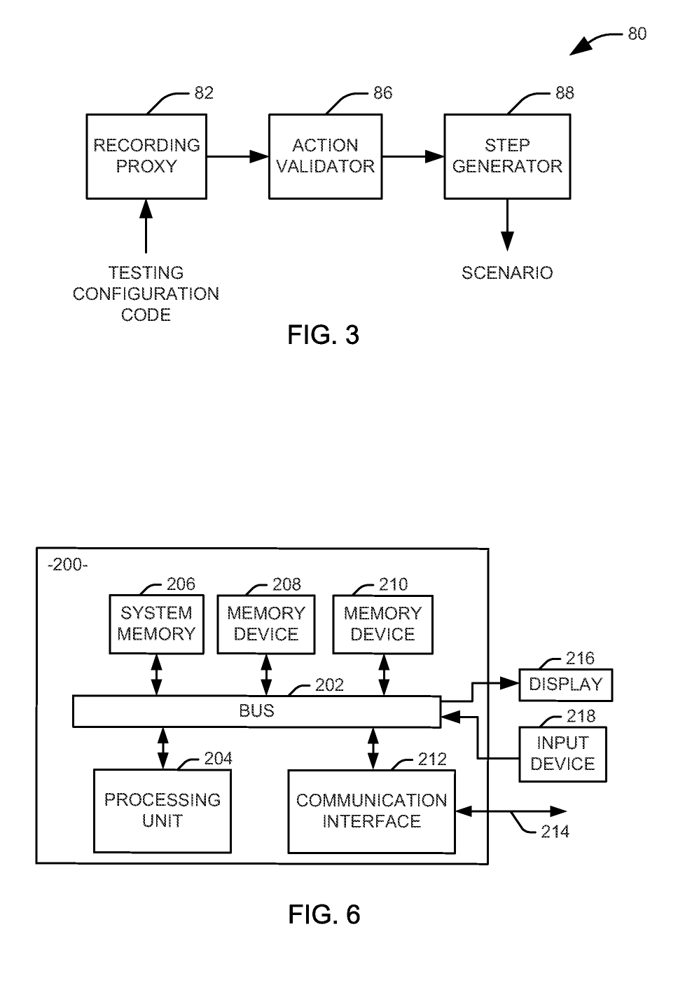

FIG. 3 illustrates a recorder system 80 for capturing desired behaviors for mock objects, including both the stand-alone mock objects and the aspects associated with composite objects, to generate testing scenarios. The recorder system 80 includes a recording proxy 82 that collects data characterizing the methods associated with the mocked real object represented by the mock object. In the illustrated implementation, the recorder 80 system utilizes a fluent application program interface to capture the desired behavior for the mocked object from a set of testing configuration code. The resulting commands are then subjected to validation checks at an action validator 86 to ensure that the determined commands are legal for a programmed interface. A step generator 88 creates the steps defining each method associated with the mocked object. For example, supported behaviors can include return values, input and output reference parameter values, exception throwing, event raising, executing callbacks. It can also establish rules for collecting data at run time for outcome analysis as well as triggers for the mock object to establish custom behavior. The steps representing one or more mocked objects can be collected into a hierarchical data structure as the scenario for a given test.

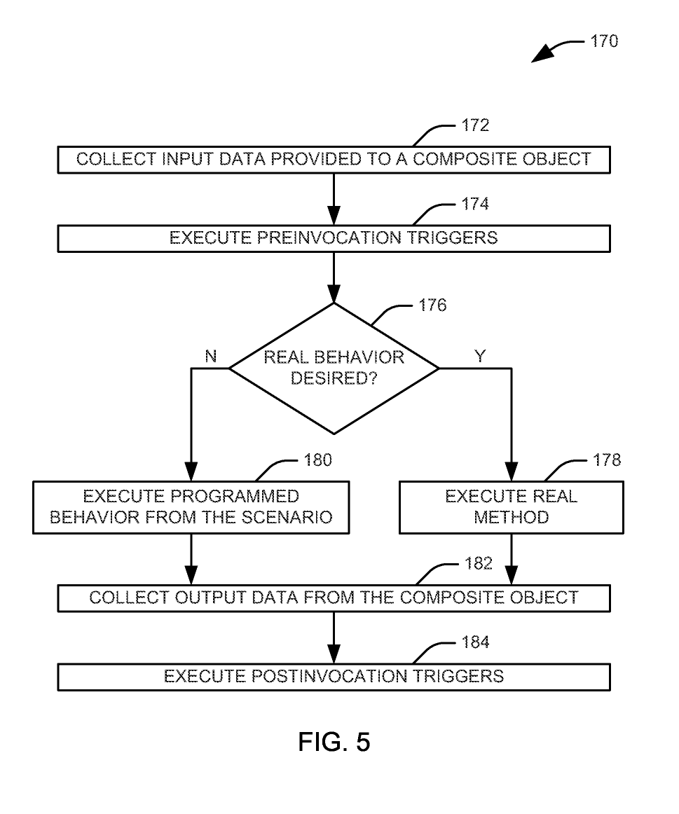

In view of the foregoing structural and functional features described above in FIGS. 1-3, example methodologies will be better appreciated with reference to FIGS. 4 and 5. While, for purposes of simplicity of explanation, the methodologies of FIGS. 4 and 5 are shown and described as executing serially, it is to be understood and appreciated that the present invention is not limited by the illustrated order, as some actions could in other examples occur in different orders and/or concurrently from that shown and described herein.

FIG. 4 illustrates one method 150 for testing an integrated software system. It will be appreciated that the method 150 can be implemented as machine readable instructions stored on one or more non-transitory computer readable media and executed by associated processor(s). At 152, a scenario is generated as a hierarchical data object in which configuration parameters for each of a plurality of methods associated with a mock object are related to associated method signatures. The testing scenario models the behavior of mock objects used in testing the integrated software system. Accordingly, a recording component can be used to capture the desired behavior of the mock object and store it in the scenario, which is a complex data structure called that relates the configuration uniquely to type and method signatures associated with the mock object. It will be appreciated that a given scenario can represent multiple mock objects. Along with programmed behavior for the mock object, the configuration parameters can include instructions for each of a plurality of methods associated with the mock object to execute, in response to invocation of the method, either the programmed behavior associated with the mock object or the actual method at the real object.

In one implementation, the scenario is generated using an appropriate object creation tool such as a design pattern or a fluent application program interface. The determined configuring code can be validated to ensure that the programming is correct in respect to the programmed interface. For example, it can be verified that input parameters, output parameters, and return values are specified correctly, and various errors are checked for that can caught at compile time. The scenario can also define what information will collect in runtime for each method, including specific input and output parameters, return values, number of calls, and similar values.

At 154, a mock object, implemented as a stateless dynamic proxy for a plurality of associated methods, is injected into the integrated software system. For example, the mock object can be a standalone object or as an aspect wrapped around another object in the system. This can be accomplished, for example, using aspect oriented programming (AOP) frameworks, using intermediate language or byte code weaving, or code instrumentation. It will be appreciated that the stateless nature of mock objects simplifies injection of the mock object into the system in a manner consistent with the arrange, act, assert (AAA) model, allowing the test code be to free from the burden of complex injection leaving it cleaner and more maintainable and readable.

At 158, one of the real object and the mock object is invoked with the provided input data. If the mock object is invoked, the method is simulated using the configuration parameters stored at the scenario. In practice, integration testing can involve the execution of a use case on the tested system, and methods associated with the mock object can be invoked by other components in the system that interact with them. The mock object asks the scenario, via the current context, how to proceed based upon the configuration parameters and acts accordingly. As part of the invocation, execution parameters associated with the method can be updated at a result collection component. Any or all of the input data, output of the invoked method or methods, returned values, raised exceptions, and other such data can be collected prior to and during invocation of the real or mocked method. At 160, the collected data is verified according to rules associated with the method. For example, the rules can include expected input parameter values, expected output parameter values, expected return values, expected numbers of calls, expected failures for various exceptions, and a check for successful termination of the method. In one implementation, the verification is performed at a central data collection in a central testing service associated with the testing framework.

It will be appreciated that, since the mock objects are stateless, the behavior of a given mock object can be completely changed by replacing the scenario with a new scenario containing different configuration data. Similarly, by replacing the current context, that is, the scenario, the collected data, the instruction to use the real or mocked methods, and all expected results, it is possible to completely reset the testing environment without any need to recreate or reconfigure any of the mock objects. This allows for multiple situations to be tested without needing to tear down a live testing environment.

FIG. 5 illustrates one example of a method 170 for invoking a composite object in a composite applications testing framework. At 172, input data provided to the composite object is collected and provided to the testing agent. The data collected can be fine-grained and tuned such that less than all of the input data is collected. For example, for each method associated with a given object, specific input parameters can be collected. By limiting the amount of input data collected and verified, the testing can be expedited. At 174, preinvocation triggers associated with the object can be executed, either automatically in response to the input data, or in response to an event associated with either the input data or the invoking of the object. The preinvocation triggers can be added to the objects as part of the wrapping proxy to represent desired custom behaviors when the mock object is programmed.

At 176, it is determined if the real or the programmed behavior for the composite object should be invoked. This can be determined according to configuration data associated with the scenario, and can be dynamically changed by replacing the scenario. If execution of the real method is desired (Y), it is executed to prove one or more outputs at 178. If programmed behavior for the mock object is desired (N), the mock object requests programmed behavior from the scenario and acts accordingly at 180. The scenario stores programmed behavior for each of a plurality of methods associated with the mock object, and appropriate behavior can be selected and provided to the mock object according to the stored configuration data for a specific mock type and method signature. Regardless of which method is invoked, if the composite object utilizes events registration, then subscribers and publishers of a given event are recorded and mapped to allow both tracking and simulating of cross-component interactions.

At 182, output values are is collected, including any of output parameter values, returned values, and raised exceptions provided by the invoked method, and provided to a centralized data repository for verification. Like the collection of the input data, the collection of the output data can be fine-grained and tuned such that less than all of the output data is collected, such that for each method associated with a given mock object, specific output parameters, return values, and exceptions can be collected. At 184, postinvocation triggers associated with the mock object can be executed, either automatically in response to invocation of the mock object, or in response to an event associated with the object output. Like the preinvocation triggers, the postinvocation triggers can be added to the composite objects to represent desired custom behaviors when the mock object is programmed.

FIG. 6 is a schematic block diagram illustrating an exemplary system 200 of hardware components capable of implementing examples of the systems and methods disclosed in FIGS. 1-5, such as the composite applications testing system illustrated in FIGS. 1 and 2. The system 200 can include various systems and subsystems. The system 200 can be a personal computer, a laptop computer, a workstation, a computer system, an appliance, an application-specific integrated circuit (ASIC), a server, a server blade center, a server farm, etc.

The system 200 can includes a system bus 202, a processing unit 204, a system memory 206, memory devices 208 and 210, a communication interface 212 (e.g., a network interface), a communication link 214, a display 216 (e.g., a video screen), and an input device 218 (e.g., a keyboard and/or a mouse). The system bus 202 can be in communication with the processing unit 204 and the system memory 206. The additional memory devices 208 and 210, such as a hard disk drive, server, stand alone database, or other non-volatile memory, can also be in communication with the system bus 202. The system bus 202 interconnects the processing unit 204, the memory devices 206-210, the communication interface 212, the display 216, and the input device 218. In some examples, the system bus 202 also interconnects an additional port (not shown), such as a universal serial bus (USB) port.

The processing unit 204 can be a computing device and can include an application-specific integrated circuit (ASIC). The processing unit 204 executes a set of instructions to implement the operations of examples disclosed herein. The processing unit can include a processing core.

The additional memory devices 206, 208 and 210 can store data, programs, instructions, database queries in text or compiled form, and any other information that can be needed to operate a computer. The memories 206, 208 and 210 can be implemented as computer-readable media (integrated or removable) such as a memory card, disk drive, compact disk (CD), or server accessible over a network. In certain examples, the memories 206, 208 and 210 can comprise text, images, video, and/or audio, portions of which can be available in different human.

Additionally or alternatively, the system 200 can access an external data source or query source through the communication interface 212, which can communicate with the system bus 202 and the communication link 214.

In operation, the system 200 can be used to implement one or more applications in an integrated software system or one or more parts of the composite applications testing system for evaluating the integrated software system. Computer executable logic for implementing the composite applications testing system resides on one or more of the system memory 206, and the memory devices 208, 210 in accordance with certain examples. The processing unit 204 executes one or more computer executable instructions originating from the system memory 206 and the memory devices 208 and 210. The term “computer readable medium” as used herein refers to a medium that participates in providing instructions to the processing unit 204 for execution.

What have been described above are examples. It is, of course, not possible to describe every conceivable combination of components or methodologies, but one of ordinary skill in the art will recognize that many further combinations and permutations are possible. Accordingly, the invention is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A testing system for an integrated software system comprising:
a mock object implemented as machine executable instructions on a first non-transitory computer readable medium, the mock object comprising an aspect joined to a corresponding object within the integrated software system to intercept a method call associated with the corresponding object and route the method call to one of the corresponding object and programmed behavior associated with the mock object; and
a testing agent, implemented as machine executable instructions on one of the first non-transitory computer readable medium and a second non-transitory computer readable medium, to instruct the aspect to route the method call to the one of the corresponding object and the programmed behavior associated with the mock object.

2. The testing system of claim 1, the testing agent comprising a scenario to store configuration data, representing the programmed behavior associated with the mock object, for a plurality of methods associated with the corresponding object.

3. The testing system of claim 2, wherein the mock object is one of a plurality of mock objects, and the scenario comprises a hierarchical data structure storing configuration data for each of the plurality of mock objects.

4. The testing system of claim 1, the testing agent further comprising a results collection component to collect input data and outputs from one of the mock object and the corresponding object.

5. The testing system of claim 4, the testing agent further comprising a scenario to store data collection rules, the results collection component using the data collection rules to selectively collect an input parameter from the input data and one of an output parameter value, a returned value, and a raised exception from the outputs.

6. The testing system of claim 4, the testing agent comprising one testing agent of a plurality of testing agents and the testing system further comprising a testing service to receive the collected input data and outputs from the results collection component in each of the plurality of testing agents, the testing service comprising a data inspection component to verify that the collected input data and output from the one of the mock object and the corresponding object have respective expected values.

7. The testing system of claim 6, the mock object comprising one mock object of a plurality of mock objects in the testing system, and each of the plurality of testing agents comprising a scenario to store configuration data, representing programmed behavior associated with the plurality of mock objects, the testing service distributing the scenario to each of the plurality of testing agents.

8. The testing system of claim 1, the mock object being one of a plurality of mock objects, and the testing system further comprising a data binding model in which each of the plurality of mock objects are linked to a property bag that stores data from the mock object.

9. A non-transitory computer readable medium storing machine readable instructions which when executed by a processor, perform a method comprising:
generating a scenario as a hierarchical data object in which configuration parameters defining programmed behavior for a mock object representing a plurality of methods associated with a real object in an integrated software system are related to an associated method signature, the configuration parameters including an instruction for the mock object to route a call to a given method of the plurality of methods associated with the real object to one of the given method and the programmed behavior for the mock object; and
injecting the mock object, implemented as an aspect wrapped around the real object for the plurality of methods, into the integrated software system.

10. The medium of claim 9, wherein the method further comprises:
receiving the call to the given method;
executing the one of the given method and the programmed behavior for the mock object; and
collecting an output from the one of the given method and the programmed behavior, the collected output comprising one of an output parameter value, a returned value, and a raised exception provided by the invoked mock object and providing the output to a testing agent.

11. The medium of claim 10, wherein the method further comprises verifying the collected output against an expected output.

12. The medium of claim 10, wherein executing the one of the given method and the programmed behavior for the mock object involves an event having a registered subscriber, the method further comprising recording one of a subscriber and a publisher associated with the event.

13. The medium of claim 9, wherein the method further comprises generating a new scenario having a new set of configuration parameters associated with the mock object such that the mock object is instructed to route a call to a corresponding method of the plurality of methods associated with the real object to an other of the method and the programmed behavior for the mock object.

14. The medium of claim 9, wherein the method further comprises executing a trigger associated with the mock object in response to an event associated with one of input data and the invoking of the mock object.

15. A testing system for an integrated software system comprising:
a mock object implemented as machine executable instructions on a first non-transitory computer readable medium, the mock object comprising an aspect joined to a corresponding object within the integrated software system to intercept a method call associated with the corresponding object and route the method call to one of the corresponding object and programmed behavior associated with the mock object; and
a testing agent, implemented as machine executable instructions on one of the first non-transitory computer readable medium and a second non-transitory computer readable medium, to instruct the aspect to route the method call to the one of the corresponding object and the programmed behavior associated with the mock object, the testing agent comprising:
a results collection component to collect input data and outputs from one of the mock object and the corresponding object and provide the collected input data and outputs to a testing service, the testing service comprising a data inspection component to verify that the collected input data and output from the one of the mock object and the corresponding object has respective expected values; and
a scenario to store configuration data for a collection of methods associated with the mock object, the configuration data including data collection rules for the mock object, the results collection component using the data collection rules to selectively collect an input parameter from the input data and one of an output parameter value, a returned value, and a raised exception from the outputs.
